(19) United States
(12) Patent Application Publication
(10) Pub. No.: US 2010/0321247 A1
(43) Pub. Date: Dec. 23, 2010

(54) Compact antenna assembly

(75) Inventor: Huei Chi Wu, Tauyuan Hsien (TW)

Correspondence Address: CHARLES E. BAXLEY, ESQUIRE, 90 JOHN STREET, SUITE 403, NEW YORK, NY, 10038, US

(73) Assignee: Joymax Electronics Co., Ltd.

(21) Appl. No.: 12/456,530

(22) Filed: Jun. 17, 2009

(51) Int. Cl. H01Q 1/36

(52) U.S. Cl. 343/700 MS; 343/786

(57) ABSTRACT

An antenna assembly includes a substrate, a conductive radiating element disposed above the substrate and preferably arranged parallel to the substrate and connected to the substrate with an interconnecting element, an antenna conductor extended from the conductive radiating element and extended or disposed between one side of the substrate and the conductive radiating element, and a conductive member extended downwardly from the conductive radiating element and arranged between the substrate and the conductive radiating element and having a feed spaced from the substrate for allowing the bandwidth of the antenna assembly to be suitably increased.

### BACKGROUND OF THE INVENTION

1. Field of the Invention

The present invention relates to an antenna assembly, and more particularly to a compact antenna assembly including a structure for allowing the size or volume or dimension of the antenna assembly to be suitably reduced or decreased and for allowing the bandwidth of the antenna assembly to be suitably increased.

2. Description of the Prior Art

Typical antenna devices comprise one or more antenna conductors or conductive branches disposed on a substrate and each having one or more feeds extended therefrom, and the conductive branches are provided for transmitting or receiving waves or signals and for allowing the radiators to transmit or to receive waves or signals or different resonant frequencies.

For example, U.S. Pat. No. 6,417,809 to Kadambi et al. discloses one of the typical compact dual diversity antenna devices for radio frequency data and wireless communication devices and comprising one or more antenna conductors or conductive branches or planar inverted F antenna members provided on a printed circuit board for use within wireless communication devices, such as radiotelephones, and for jointly radiating as a dipole antenna.

However, the antenna conductors or the conductive branches or planar inverted F antenna members include a great size or dimension or area such that the size or dimension or area of the wireless communication devices also may not be suitably decreased, such that the size or dimension or area of the typical compact dual diversity antenna device is further required to be reduced or decreased.

U.S. Pat. No. 6,861,986 to Fang et al. disclose the further typical multiple frequency antenna device for use within wireless communication devices and comprising one or more antenna conductors or radiating elements disposed on a grounding element and spaced apart from the radiating elements.

However, similarly, the antenna conductors or the radiating elements and the grounding element include a great size or dimension or area such that the size or dimension or area of the wireless communication devices also may not be suitably decreased, such that the size or dimension or area of the typical antenna device is also required to be reduced or decreased.

The present invention has arisen to mitigate and/or obviate the afore-described disadvantages of the conventional antenna members or devices.

### SUMMARY OF THE INVENTION

The primary objective of the present invention is to provide an antenna assembly including a structure for allowing the size or volume or dimension of the antenna assembly to be suitably reduced or decreased and for allowing the bandwidth of the antenna assembly to be suitably increased.

In accordance with one aspect of the invention, there is provided an antenna assembly comprising a substrate, a conductive radiating element disposed above the substrate and connected to the substrate with an interconnecting element, an antenna conductor extended from the conductive radiating element, and a conductive member extended downwardly from the conductive radiating element and arranged between the substrate and the conductive radiating element, and including a feed spaced from the substrate.

The conductive member includes a cone-shaped structure, or the conductive member includes an elliptical cross section.

The antenna conductor preferably includes an L-shaped structure.

The conductive radiating element includes one side connected to one side of the substrate with the interconnecting element.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation or the attachment or the engagement of an antenna assembly in accordance with the present invention in a wireless communication device, such as radiotelephone or notebook;

FIG. 2 is a perspective view illustrating the construction of the antenna assembly;

FIG. 3 is a plan schematic view of the antenna assembly; land

FIG. 4 is a plan schematic view illustrating the voltage standing wave ratio of the antenna assembly.

### DETAILED DESCRIPTION OF THE PREFERRED EMBODIMENT

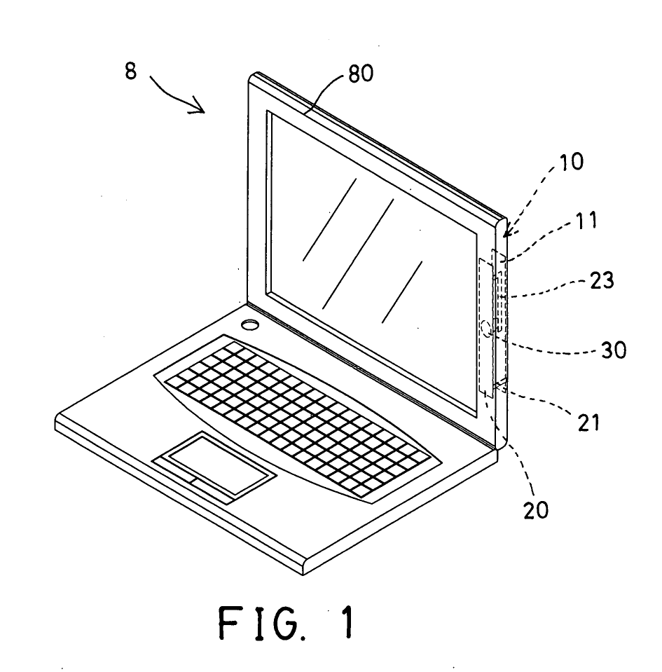

Referring to the drawings, and initially to FIG. 1, an antenna assembly 10 in accordance with the present invention is provided for use within wireless communication devices 8, such as radiotelephones, mobile phones, notebooks 8, etc., and such as attached to or disposed in a displayer or screen 80 of the notebook 8, in which the antenna assembly 10 includes a reduced or decreased size or volume or area or dimension for allowing the size or volume or area or dimension of the wireless communication device 8 or the notebook 8 also to be suitably reduced or decreased and for allowing the bandwidth of the antenna assembly 10 to be suitably increased.

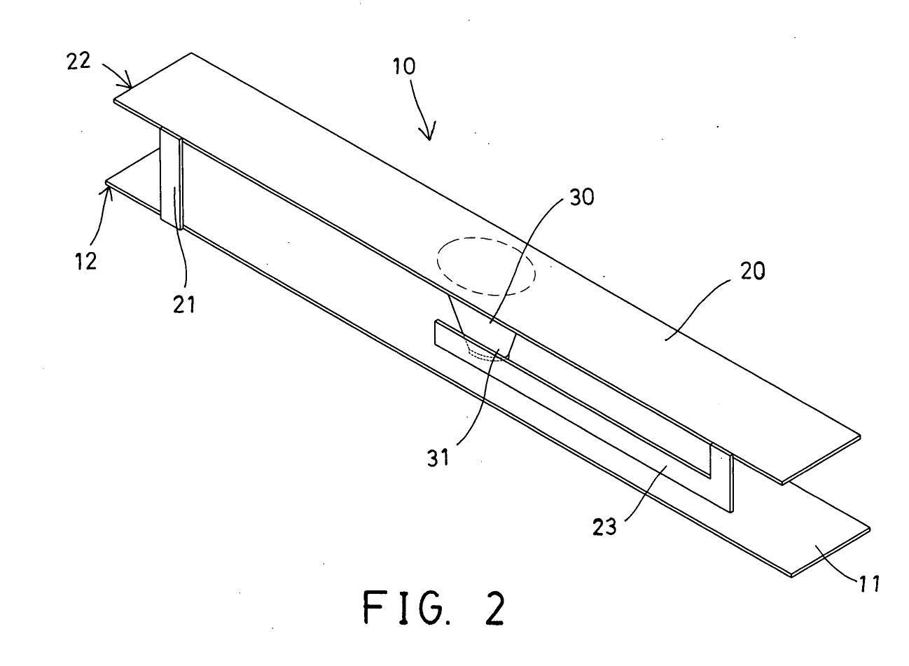

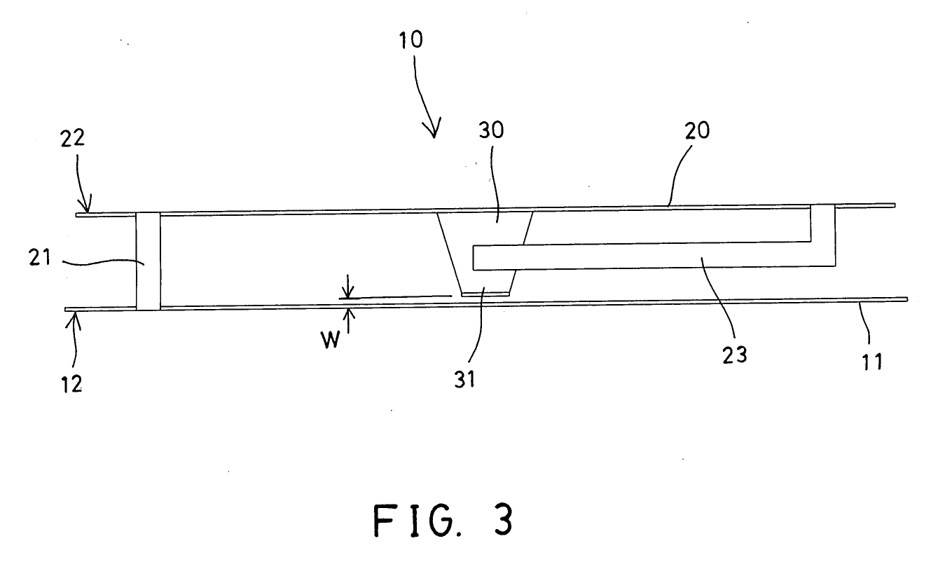

As shown in FIGS. 2-3, and also shown in FIG. 1, the antenna assembly 10 comprises a circuit board or earth plate or substrate 10, and another substrate or circuit board or antenna conductor or conductive radiating element 20 disposed above the substrate 10 and disposed and arranged parallel to the substrate 10 and connected or coupled to the substrate 10 with an interconnecting element 21, it is preferable that the interconnecting element 21 is disposed or extended between one sides 12, 22 of the substrate 10 and the conductive radiating element 20.

The antenna assembly 10 in accordance with the present invention further comprises an antenna conductor 23 extended from the one side 22 of the conductive radiating element 20 and inclined or perpendicular to the conductive radiating element 20 and extended or disposed and arranged between the one sides 12, 22 of the substrate 10 and the conductive radiating element 20, and including a substantially L-shaped structure for allowing the conductive radiating element 20 and the antenna conductor 23 to have different resonant paths and for allowing the bandwidth of the antenna assembly to be suitably increased.

The antenna assembly 10 in accordance with the present invention further comprises a cone-shaped antenna or conductive member 30 extended downwardly from the conductive radiating element 20, and disposed and arranged between the substrate 10 and the conductive radiating element 20, and including a cone-shaped structure having an oval or elliptical cross section, and including a lower end or feed 31 spaced from the substrate 10 and having a gap or depth or width formed between the substrate 10 and the feed 31 of the conductive member 30.

It is to be noted that the size or volume or area or thickness or dimension of the conductive member 30 may be adjusted or decreased or increased in order to adjust the impedance of the feed 31 of the conductive member 30, and for allowing the antenna assembly 10 in accordance with the present invention to be used for wireless fidelity (WiFi) whose working frequency is ranged between 2.4 GHz and 2.5 GHz, and also ranged between 5.15 GHz and 5.85 GHz, and to be used for worldwide interoperability for microwave access (WiMAX) whose working frequency is ranged between 2.3 GHz and 2.7 GHz, and also ranged between 3.3 GHz and 3.8 GHz.

In operation, as shown in FIG. 1, when the antenna assembly 10 in accordance with the present invention is attached or disposed in a displayer or screen 80 of the radiotelephones, or the mobile phones, or the notebook 8 or the other wireless communication devices 8, the antenna conductor 23 of the conductive radiating element 20 may have different resonant paths from that of the conductive radiating element 20 for allowing the bandwidth of the antenna assembly 10 to be suitably increased and also for allowing the size or volume or area or dimension of the wireless communication device 8 or the notebook 8 to be suitably reduced or decreased.

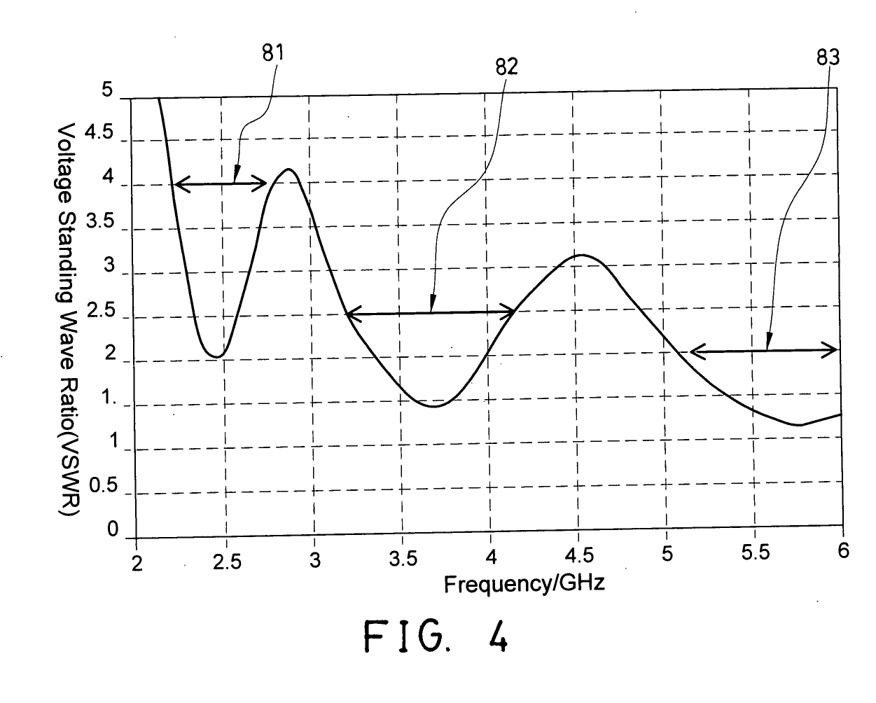

As shown in FIG. 4, illustrated is the voltage standing wave ratio of the antenna assembly 10, and from the voltage standing wave ratio of the antenna assembly 10 we may see that the antenna assembly 10 in accordance with the present invention is working well within the working frequencies 81, 82, 83 that are ranged between 2.3 GHz and 2.7 GHz, 3.3 GHz and 3.8 GHz, and 5.15 GHz and 5.85 GHz, and is thus workable for wireless fidelity (WiFi) whose working frequency is ranged between 2.4 GHz and 2.5 GHz, and 5.15 GHz and 5.85 GHz, and is also workable for microwave access (WiMAX) whose working frequency is ranged between 2.3 GHz and 2.7 GHz, and 3.3 GHz and 3.8 GHz.

Accordingly, the antenna assembly in accordance with the present invention includes a structure for allowing the size or volume or dimension of the antenna assembly to be suitably reduced or decreased and for allowing the bandwidth of the antenna assembly to be suitably increased.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna assembly comprising:
a substrate,
a conductive radiating element disposed above said substrate and connected to said substrate with an interconnecting element,
an antenna conductor extended from said conductive radiating element, and
a conductive member extended downwardly from said conductive radiating element and arranged between said substrate and said conductive radiating element, and including a feed spaced from said substrate.

2. The antenna assembly as claimed in claim 1, wherein said conductive member includes a cone-shaped structure.

3. The antenna assembly as claimed in claim 1, wherein said conductive member includes an elliptical cross section.

4. The antenna assembly as claimed in claim 1, wherein said antenna conductor includes an L-shaped structure.

5. The antenna assembly as claimed in claim 1, wherein said conductive radiating element includes one side connected to one side of said substrate with said interconnecting element.
